(19) United States
(12) Patent Application Publication
(10) Pub. No.: US 2016/0059396 A1
(43) Pub. Date: Mar. 3, 2016

(54) DEVICE FOR ASSEMBLING A FUEL INJECTOR ASSEMBLY

(71) Applicant: Caterpillar Inc., Peoria, IL (US)

(72) Inventors: Miguel G. Rebolloso, Nuevo Laredo (MX); Mario E. Cuellar, Nuevo Laredo (MX)

(73) Assignee: Caterpillar Inc., Peoria, IL (US)

(21) Appl. No.: 14/934,168

(22) Filed: Nov. 6, 2015

(51) Int. Cl. B25B 27/00; F02M 61/16

(52) U.S. Cl. CPC B25B 27/0035; F02M 61/168

(57) ABSTRACT

A device for assembling a fuel injector assembly is described. The device includes a stand and a body coupled to the stand. The body includes a first arm and a second arm extending from a first side and a second side of the body, respectively, to receive and rigidly hold an adapter of the fuel injector assembly therebetween. The body further includes one or more grooves provided to adjust the body in a horizontal plane with respect to the vertical member. Further, the device includes a handle coupled to the body to position the body in the horizontal plane with respect to the vertical member. The device also includes one or more pins mounted on the vertical member, where each of the one or more pins engage with a corresponding groove and aid in adjusting the body in the horizontal plane with respect to vertical member.

### TECHNICAL FIELD

The present disclosure relates to a work holding device, and more particularly to a work holding device to assist assembling of a component of a fuel injector assembly.

### BACKGROUND

With the development of technology, electronic fuel injectors have replaced mechanical fuel injectors to improve efficiency and operational characteristics of internal combustion engines. An electronic fuel injector includes multiple parts, such as a main body, a cap, and internal components. More often, the main body includes number internal components, such as pins, sleeves, electrical and electronic components, and springs. Accordingly, close attention is required during assembling process, such as placement and positioning of the internal components within the electronic fuel injector. Further, such assembling process or other testing processes may require the electronic fuel injectors to be rigidly clamped in a holding device. However, the holding device may need to be simple to operate and provide improved clamping for fuel injectors, without affecting any constructional characteristics of the fuel injectors.

US Patent Application 2014/0359986A1 ('986 application) discloses an injector holder for clamping a fuel injector, such as the electronic fuel injector, thereon. The injector holder of the '986 application serves as an adaptor to a vice to hold the fuel injector in place during disassembly and assembly. The injector holder includes opposing bracket members and including corresponding shelf members. The bracket members are coupled together via a spring loaded bolt and nut and are biased apart using a spring that is loaded on the bolt. However, the opposing bracket members of the vice causes wear on the surface of the fuel injector during assembly process of the fuel injector. In addition, the opposing bracket members fail to provide sufficient support to the fuel injector during the assembly process.

### SUMMARY OF THE DISCLOSURE

According to an aspect of the present disclosure, a device for assembling a fuel injector assembly is described. The device includes a stand having a base member, a guide member, and a vertical member. The vertical member has a first end and a second end, the first end of the vertical member coupled to the base member and the second end of the vertical member coupled to the guide member. The device further includes a holder having a first end and a second end, the first end of the holder coupled to the base member and the second end of the holder includes an annular opening adapted to receive the fuel injector. The device further includes a body coupled to the stand. The body includes a first arm extending from a first side of the body and a second arm extending from a second side of the body. The first arm and the second arm are provided to receive and rigidly hold an adapter of the fuel injector assembly therebetween. The body further includes one or more grooves configured to adjust the body in a horizontal plane with respect to the vertical member. Further, the device includes a handle coupled to the body to position the body in the horizontal plane with respect to the vertical member. The device also includes one or more pins mounted on the vertical member, where each of the one or more pins engage with a corresponding groove and aids in adjusting the body in the horizontal plane with respect to vertical member.

Other features and aspects of this disclosure will be apparent from the following description and the accompanying drawings.

### BRIEF DESCRIPTION OF THE DRAWINGS

FIG. 1 is a rear perspective view of a device for assembling a fuel injector assembly, according to concepts of the present disclosure;

FIG. 2 is a top perspective view of the device; and

FIG. 3 is a top perspective view of the device showing an operation of assembly of the fuel injector assembly with the aid of the device.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

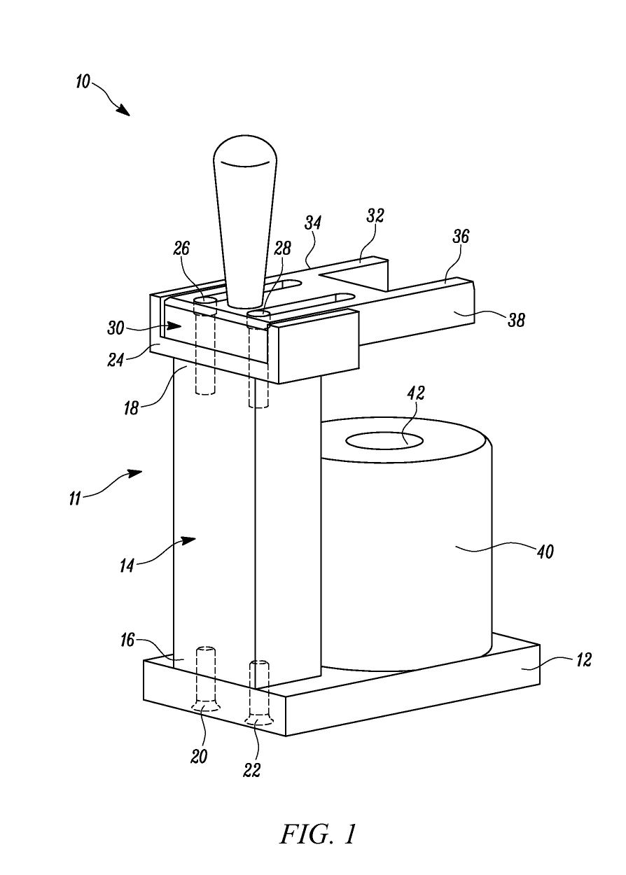

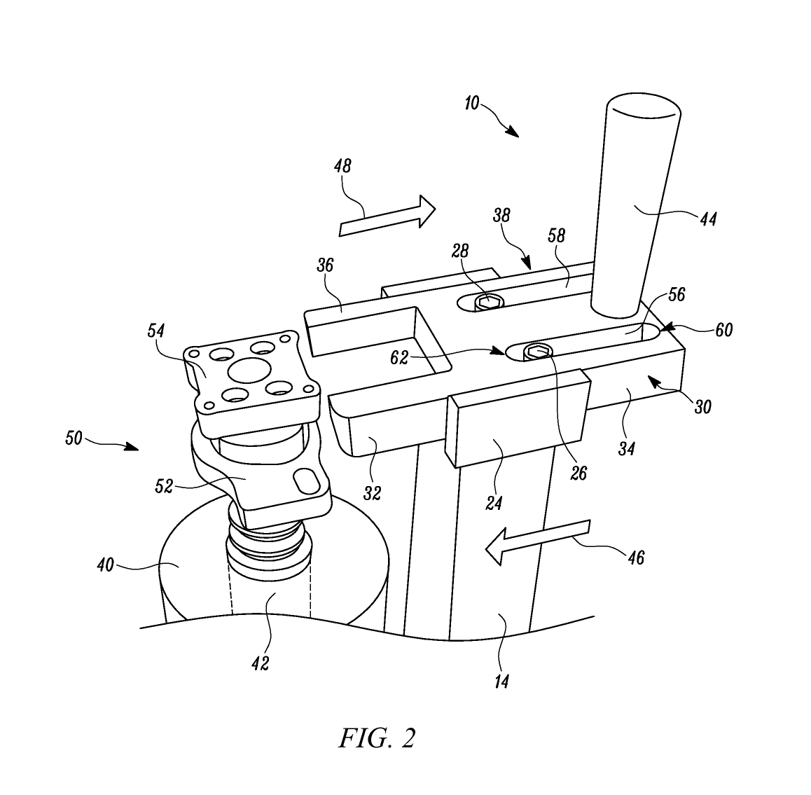

FIG. 1 shows a device 10 for assembling a fuel injector assembly 50 (shown in FIG. 2), according to one embodiment of the present disclosure. The device 10 includes a stand 11. Further, the stand 11 includes a base member 12 provided to support other components of the device 10 thereon. The base member 12 is embodied as, but not limiting to, a rectangular block. The stand 11 further includes a vertical member 14. The vertical member 14 may be understood as a bracket mounted on the base member 12 to vertically support the device 10. The vertical member 14 has a first end 16 and a second end 18. The first end 16 of the vertical member 14 is coupled to the base member 12 via a first fastener 20 and a second fastener 22. The second end 18 of the vertical member 14 is coupled to a guide member. In particular, the second end 18 of the vertical member 14 is adapted to accommodate the guide member 24 thereon. The guide member 24 may be understood as a structure that includes guides or railing to allow sliding of one or more components therein. The guide member 24 is attached to the second end 18 of the vertical member 14 via a first pin 26 and a second pin 28. In an example, the first pin 26 and the second pin 28 may be fasteners and may be mounted on the vertical member 14. The first pin 26 and second pin 28 are so coupled to the guide member 24, such that a portion of the first pin 26 and the second pin 28 extend in a direction perpendicular to a surface of the guide member 24.

The device 10 further includes a body 30 slidably disposed in the guide member 24. In an example, the body 30 may be made of iron and coated with black oxide to prevent rusting. For the purpose of receiving an adapter 54 (shown in FIG. 2) of the fuel injector assembly 50, the body 30 includes a first arm 32 extending from a first side 34 of the body 30. Further, the body 30 includes a second arm 36 extending from a second side 38 of the body 30. In an example, the first arm 32 may extend longitudinally along the first side 34 of the body 30 and the second arm 36 may extend longitudinally along the second side 38 of the body 30. The first side 34 and the second side 38 may be understood as opposite edges of the body 30 along a width of the body 30. In one example, the first arm 32 and the second arm 36 may be formed as integral part of the body 30. In another example, the first arm 32 and the second arm 36 may be separate components which can be attached to the body 30 prior to an assembly process.

In case where the first arm 32 and the second arm 36 are integral to the body 30, the first arm 32 and the second arm 36 are formed on the body 30, such that the first arm 32 and the second arm 36 can receive and rigidly hold the adapter 54 therebetween. Further, the device 10 includes a holder 40 for supporting the fuel injector assembly 50. The holder 40 includes an annular opening 42 adapted to receive the fuel injector assembly 50. The holder 40 is mounted on the base member 12 in a manner, such that the annular opening 42 is positioned below the body 30 and located between the first arm 32 and the second arm 36.

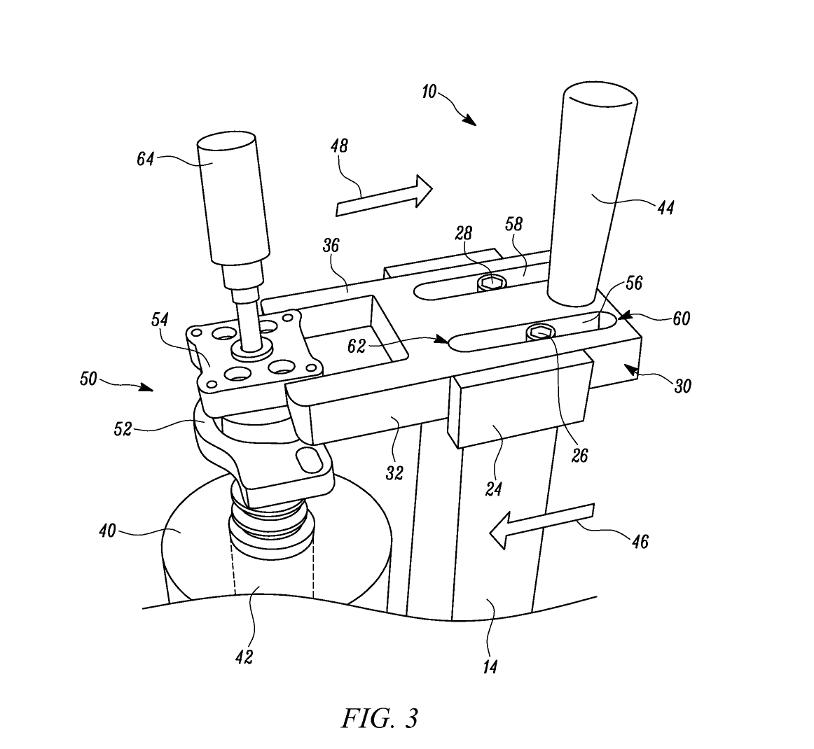

Reference will now be made to FIG. 2 and FIG. 3 to describe the manner in which the adapter 54 is accommodated between the first arm 32 and the second arm 36 of the body 30. The device 10 further includes a handle 44 attached to the body 30. The handle 44 is embodied as a protrusion that extends vertically from the top surface of the body 30 in a manner, such that the handle 44 is easily graspable by an operator. In one example, the handle 44 may be provided with a grip, so that the operator can flexibly hold the handle 44 to access the device 10. The handle 44 is provided to aid in positioning the body 30 at a desired position in the horizontal plane with respect to the vertical member 14.

The handle 44 facilitates the sliding movement, or the to-and-fro movement, of the body 30. For instance, an operator can hold the handle 44 and move the body 30 in a first direction 46 and a second direction 48. Accordingly, the body 30 is moved between a first position F1 and a second position F2. FIG. 2 also shows the fuel injector assembly 50 mounted on the holder 40. The fuel injector assembly 50 includes a clamp 52 and an adapter 54 rotatably mounted on the clamp 52. Prior to the assembly operation, the first arm 32 and second arm 36 are positioned away from the fuel injector assembly 50 as shown in FIG. 2.

The device 10 further includes a first groove 56 and a second groove 58 to assist in movement of the body 18 between the first position F1 and the second position F2. Further, the first groove 56 and the second groove 58 extend in a longitudinal direction of the body 30 and are provided to adjust the body 30 in a horizontal plane with respect to the vertical member 14. The horizontal plane may be understood as a plane that contains a top surface of the body 30. The first groove 56 and the second groove 58 extend from a top surface to a bottom surface of the body 30 along a portion of the body 30, as shown in the FIG. 2. In another embodiment, the first groove 56 and the second groove 58 can extend to a predetermined distance from the bottom surface of the body. Further, the body 30 is so mounted on the guide member 24, such that the first groove 56 receives the first pin 26 and the second groove 58 receives the second pin 28. As described earlier, the first pin 26 and the second pin 28 extend in the direction perpendicular to the surface of the guide member 24. Accordingly, the first pin 26 and the second pin 28 enable to position the body 30 on the guide member 24 through the first groove 56 and the second groove 58. Each of the first groove 56 and the second groove 58 has a first end and a second end.

For the purpose of convenience in description, the ends of the first groove 56 are only considered to describe the first position F1 and the second F2 of the body 30. The first groove 56 includes a first end 60 and a second end 62. In the first position F1, the body 30 is positioned away from the adapter 54. In this position, the first pin 26 is either in contact with the second end 62 of the first groove 55 or is in vicinity of the second end 62 of the first groove 56.

Once the adapter 54 is mounted on the clamp 52, the body 30 is moved in the first direction 46 with the aid of the handle 44. Accordingly, the first arm 32 and the second arm 36 of the body 30 moves along the sides of the adapter 54 and abut the side surfaces of the adapter 54. As such, the adapter 54 is held between the first arm 32 and the second arm 36. In one example, the distance between the first arm 32 and the second arm 36 may be predetermined based on the width of the adapter 54. An engaged position of the first arm 32, the second arm 36, and the adapter 54 can be understood as the second position F2 of the body 30. In the second position F2, the first pin 26 is either in contact with the first end 60 of the first groove 56 or in vicinity of the first end 60 of the first groove 56, as shown in FIG. 3. As such, the first pin 26 and the second pin 28 restrict the movement of the body 30 beyond the first position F1 and the second position F2. It will be understood that a distance by which the body 30 is moved can be determined by providing a corresponding length of the groove.

Various embodiments disclosed herein are to be taken in the illustrative and explanatory sense, and should in no way be construed as limiting of the present disclosure.

### INDUSTRIAL APPLICABILITY

The present subject matter describes the device 10 for assembling the fuel injector assembly 50. In particular, the present disclosure describes the device 10 used for assembling the adapter 54 to the fuel injector assembly 50. In one example, the fuel injector may be a hydraulically actuated electronic unit injector (HEUI).

FIG. 3 shows an operation of assembling the fuel injector assembly 50 with the aid of the device 10. In operation, the adapter 54 of the fuel injector assembly 50 is held in one hand of the operator and the device 10 may be positioned to hold the adapter 54. In other words, while the adapter 54 of the fuel injector assembly 50 is held in one hand, the operator may hold the handle 44 of the device 10 in other hand. Subsequently, the handle 44 is pulled to position the first arm 32 and the second arm 36 of the body 30 at a desired position with respect to the adapter 54. Further movement of the handle 44 towards the adapter 54 causes the first arm 32 and the second arm 36 to abut respective side surfaces of the adapter 54, thereby holding the adapter 54. Thereafter, the operator's hands are set free, which otherwise had to hold the adapter 54 throughout the assembly operation.

Subsequently, the operator will be able to hold a rotating tool 64 with both hands and perform the assembly operation for assembling the fuel injector assembly 50. In other words, both the hands of the operator can be used to hold a body of the rotating tool 64. As such, the operator's hand would be away from the rotating tool 50, thereby ensuring safety of the operator. In addition, owing to the movement of the body 30 in the first direction 46 and the second direction 48 towards and away from the operator respectively, the body 30 can be moved to the desired position to receive the adapter 54. It will be understood by the one skilled in the art that the distance between the first arm 32 and the second arm 36 may be varied by increasing the width of the body 30, to accommodate adapters of various widths. Therefore, the device 10 of the present disclosure provides improved clamping for the adapter 54 of the fuel injector assembly 50 whilst providing safety to the operator. Although the description herein is described with respect to an operator, it will be appreciated that the phrase ‘operator's hand(s)’ are recited for the mere purpose of description and should not be construed as a limitation. In an example, arms of a machine can be used to hold the rotating tool 64.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A device for assembling a fuel injector assembly, the device comprising:
a stand having:
a base member;
a guide member; and
a vertical member having a first end and a second end, the first end of the vertical member coupled to the base member and the second end of the vertical member coupled to the guide member;
a holder having a first end and a second end, the first end of the holder coupled to the base member and the second end includes an annular opening adapted to receive the fuel injector assembly;
a body coupled to the stand, the body comprising:
a first arm extending from a first side of the body;
a second arm extending from a second side of the body, the second arm and the first arm structured and arranged to receive and rigidly hold an adapter of the fuel injector assembly therebetween; and
one or more grooves provided to adjust the body in a horizontal plane with respect to the vertical member;
a handle coupled to the body, the handle provided to position the body in the horizontal plane with respect to the vertical member; and
one or more pins mounted on the vertical member, each of the one or more pins adapted to engage with a corresponding groove and further adapted to adjust the body in the horizontal plane with respect to the vertical member.
